(19) United States
(12) Patent Application Publication
(10) Pub. No.: US 2005/0175403 A1
(43) Pub. Date: Aug. 11, 2005

(54) Junction connector

(76) Inventors: Armin Herb, Apfeldorf (DE); Armin Hoffmann, Landsberg (DE)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 11/053,405

(22) Filed: Feb. 8, 2005

(30) Foreign Application Priority Data
Feb. 9, 2004 (DE) 10 2004 006 210.2

(51) Int. Cl. H02N 2/00

(52) U.S. Cl. 403/346

(57) ABSTRACT

The invention relates to a node connector, in particular for suspension constructions, which has at least two passages (11, 12) each for at least one rod-shaped construction element and which has at least one connection receiving part (13) for a third construction element. The passages (11, 12) are slot-shaped in their configuration and arranged laterally offset to each other in parallel running planes (41, 42).

### BACKGROUND OF THE INVENTION

The invention relates to a node or junction connector, in particular for suspension constructions, which has at least two passages each for at least one rod-shaped construction element and which has at least one connection receiving part for a third construction element.

This type of junction connector is used with suspension constructions in steel and reinforced concrete industrial halls. Here, the suspension constructions are used in the installation of utilities and process media. For large area fastening means, in the case of suspended constructions, mounting rails are suspended gridlike on the hall beams Because of the large beam intervals of the support construction, the suspension construction must be executed perpendicular and diagonally from the beam to the rail grid. In this case, the diagonal suspension is brought together in node points and connected using junction fasteners.

DE 200 16 876 U1 discloses a bearing structure having rod-shaped structural components and having node connectors. The node connectors have two hemi-shells, each of which have at their facial surfaces a depression to receive a rod-shaped structural component and each which have lateral recesses, which extend into the adjacent areas of the hemi-shells radially outward towards the lateral peripheral surface and are arranged in a mirror-image arrangement relative to each other for receiving rod-shaped structural components. After introducing the rod-shaped structural components into the recesses of the first hemi-shell and after applying the second hemi-shell, the two hemi-shells are clamped together using screws to form a node or junction connector.

The high cost in the assembly of the node connectors with the rod-shaped structural components and the fact that the length of the rod-shaped structural components must be adapted precisely to the spatial situation of the node connector in the bearing structure are drawbacks.

Furthermore, DE 32 24 986 A1 discloses a construction for fastening assembly parts to a concrete wall. This construction comprises a connector having two sections: a first section having a passage for a first rod-shaped structural component and a second section, which is pivotally connected with the first section and which has a passage for a second rod-shaped structural component.

The drawback in this solution is the fact that only two rod-shaped structural components can be joined together and that when clamping the two rod-shaped structural components a greater part of the stress lies on the pivot bearing between the two sections.

### SUMMARY OF THE INVENTION

The object of the present invention is to provide a node connector that eliminates the aforesaid drawbacks and is capable of bearing high loads.

This object is achieved according to the invention in that the passages for the rod-shaped construction elements are configured rod-shaped and are arranged laterally offset relative to each other in parallel-running planes.

By virtue of this step, an easy-to-assemble node connector is provided, wherein the rod-shaped construction elements are passed alongside each other in the node connector, such that the length of the construction elements no longer influence the height of the node connector in the suspension construction. In addition, the tensile load of the entire node connection is diminished, which results in long service life of the constructions produced.

When this is done, the node connector can have a disklike cylindrical appearance; that is, it can be configured as flat cylindrical, discoid bodies, at whose cylinder sleeve surface the passages emerge. In this fashion, a compact node connector is provided which supports centering and adjustment of the rod-shaped construction elements.

In an advantageous, materially economical variant of the invention, the passages are open to each other, at lease zonally.

Furthermore, it is advantageous if at least one slot floor of the a passage has a conical course with a passage that narrows towards the inside. By virtue of this step, inclined guide surfaces are present on the slot floor, which allow easy insertion of the rod-shaped construction elements into the slot-shaped passages and which make a wide range of variation in the possible crossing angles of the rod-shaped construction elements relative to each other possible.

Advantageously, each passage has two slot floors, each of which have a conical shape tapering towards the inside of the passage and those at the narrowest position have a separation from one another equivalent to at least the inside diameter of the passages. When this is done, an optimum guidance of the rod-shaped construction elements is made possible.

An advantageous symmetry with optimum load distribution is obtained when the passages are arranged at both sides of a central plane of the node connector.

Support points for anchoring elements of the rod-shaped construction elements are advantageous at the outlet openings of the passages on the outside surface of the node connector so that a technically simple purchase means is created for said anchorages.

The symmetry of the node connector and the passages is optimum if the slot floor(s) of the one passage relative to an axis of rotation defined by the connection receiving part of the node connector are configured rotationally symmetrical to the slot floor(s) of the other passages, whereby the rotational symmetry of a double rotational axis results.

Advantageously, a material bridge penetrates both passages in a symmetrical spacing relative to the slot floors of the two passages, whereby the spacing is equivalent to at least the inner diameter of the passages. When this is done, the material bridge is advantageously configured as a bolt, whereby the production costs are kept low. In this case, the shell surface of the bolt acts as a reduced second slot floor. By turning the preferably threaded bolt, the two passages can be drawn together. The two rod-shaped construction elements in the passages such as two threaded rods, for example, are consequently clamped and checked against twisting.

### BRIEF DESCRIPTION OF THE INVENTION

Other advantages and procedures of the invention will become apparent from the description of the exemplary embodiments with reference to the drawings, wherein:

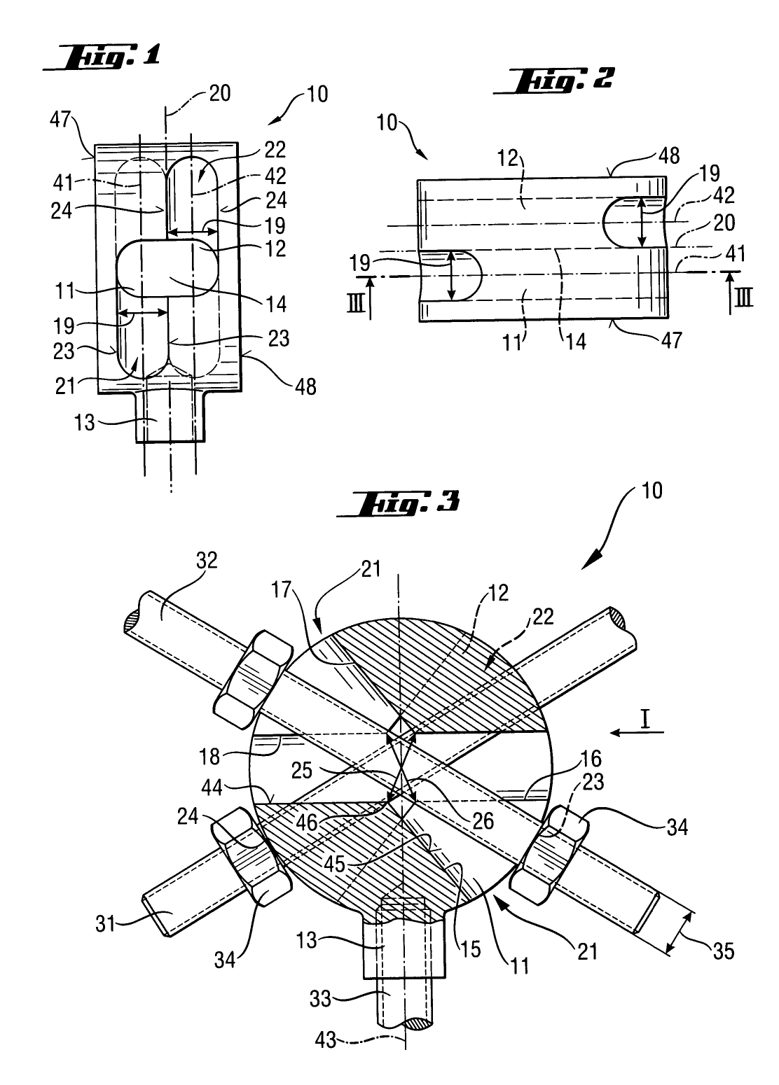

FIG. 1 shows a lateral view in direction I onto a node connector according to the invention;

FIG. 2 shows a top view onto the node connector of FIG. 1;

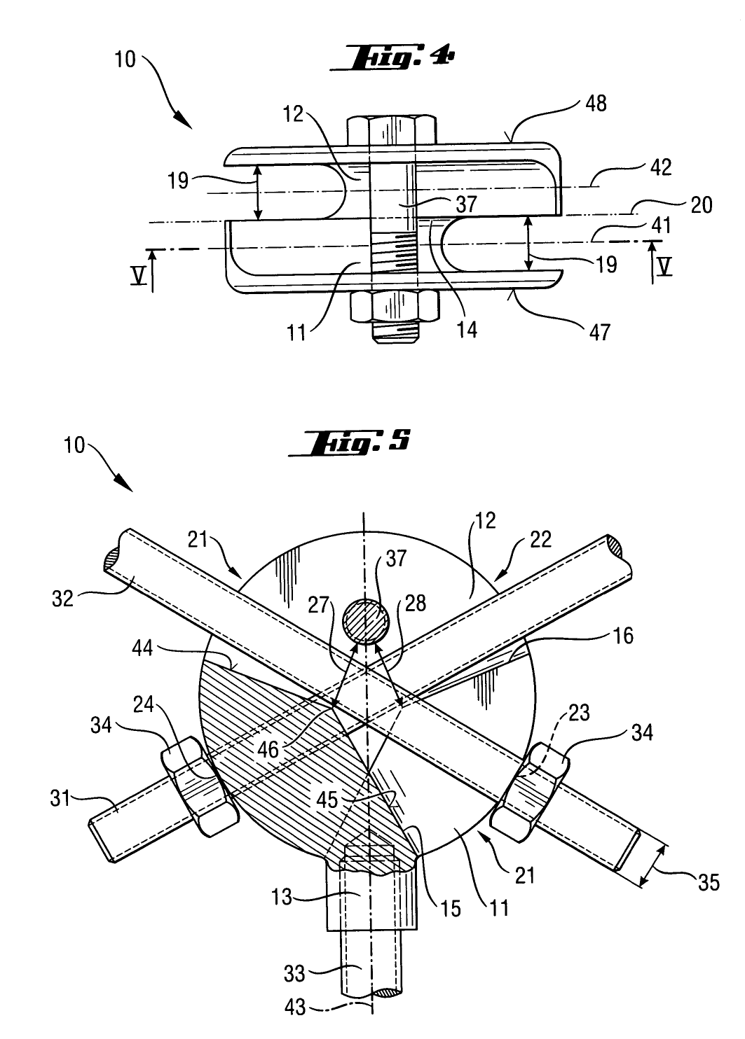

FIG. 3 shows a section along the line III-III of FIG. 2 through the node connector with the rod-shaped components arranged in the passages;

FIG. 4 shows a top view onto another node connector according to the invention; and

FIG. 5 shows a section along the line V-V of FIG. 4 through the node connector with the rod-shaped components arranged in the passages.

### DETAILED DESCRIPTION OF THE INVENTION

In the exemplary embodiment shown in FIGS. 1 to 3, the node connector 10 according to the invention has a flat cylindrical external form or habitus and is configured in one piece. Two slot-shaped passages 11, 12 are created in the node connector 10 for receiving rod-like construction elements 31, 32 such as threaded rods, for example, which are each arranged to one side of a central plane 20 of the node connector 10. The passages 11, 12 open relative to each other in an open zone 14 situated in the central plane 20. The slot-shaped passages 11, 12 define planes 41, 42 which run parallel to each other and parallel to the central plane 20 of the node connector 10. Axially outward, the passages 11, 12 are delimited by circular outer walls 47, 48 of the node connector.

The passages 11, 12, with their central axis, do not run in the same direction in the node connector 10 but at angles to each other, of which the acute angle is preferably between 35° and 75° and the obtuse angle is between 145° to 105°.

The slot-shaped passages 11, 12 are delimited along their longitudinal course by an exit opening 21, 22 relative to the opposing exit opening 21, 22 by two, essentially opposing, slot floors 15, 17 and 16, 18. These slot floors 15, 16, 17, 18 each have a conical course, whereby the slot-shaped passages 11, 12 are tapered towards the inside of the node connector 10. Moreover, the slot floors 15, 16, 17, 18 have two rising surface sectors 44, 45 approximately in the direction of the center of the node connector, which meet at a culmination point 46. In the zone of the culmination point 46, the distance 25, 26 between the slot floors 15, 17 and 16, 17 are at least as large as the open diameter 19 of the slot-shaped passages 11, 12. Consequently, the open diameter 19 of the slot-shaped passages 11, 12 is adapted to the thickness 35 or the diameter of construction elements 31, 32 to be used with the node connector and the rod-shaped construction elements 31, 32.

The slot floors 15, 17 and 16, 18 on both sides of the central plane 20 of the node connector 10 are symmetrically arranged at the node connector 10, which follows a 2 digit axis of rotation. In this instance, the axis of rotation 43 lies in the central plant 20 and is coaxial with a connection receiving part 13 for a third construction element 33 such as a threaded rod, for example. This double rotational symmetry means that after a 180° turn about the axis of rotation 43 of the node connector, it is brought automatically to covering.

The node connector 10 is represented in FIG. 3 with rod-shaped construction elements 31, 32, in the form of threaded rods, arranged in the passages 11, 12. These rod-shaped construction elements 31, 32 are, for example, affixed using connectors (not shown here) on the supports of a hall construction. Because of the laterally offset arrangement of the passages 11, 12 relative to the central plane 20 of the node connector 10, both rod-shaped construction elements 31, 32 can be lead passing by each other in the node connector. The rod-shaped construction elements 31, 32 can be anchored to the node connectors 10 using anchoring elements 34 such as nuts that engage at support points 23, 24 on the edges of the exit openings 21, 22 of the passages 11, 12. Adjustment of the node connector 10 in the suspension construction relative to its height and for centering of the rod-shaped construction elements 31, 32 is also possible when nuts or similar threaded material is used.

A further construction element configured as a threaded rod is affixed in the connection receiving part 13, on which a mounting rail of a ceiling suspension is arranged.

The further node connectors 10 represented in FIGS. 4 and 5 differ from those previously described in FIGS. 1 to 3 merely in that the slot floors 17, 18 as counter bearings of slot floors 15, 16 are reduced on the shell surface of a bolt 37, which penetrates somewhat above the center of the node connector 10. Also in this variant, the smallest separation 27, 28 between the slot floor 15, 16 and the shell surface of the bolt 37 is at least as large as the open slot width 19. With regard to the other (not mentioned herein) references, reference is made to the previous description of FIGS. 1 to 3 in their entirety.

1. A node connector for suspension constructions having at least two passages (11, 12) each for at least one rod-shaped construction element (31, 32) and having at least one connection receiving part (13) for a third construction element (33), wherein the passages (11, 12) are slot-shaped and arranged laterally offset to each other in planes (14, 42) running parallel to each other.

2. The node connector of claim 1, wherein the passages (11, 12) are at least zonally open to each other.

3. The node connector of claim 1, wherein at least one slot floor (15, 16, 17, 18) of a passage (11, 12) has a conical course tapering the passage (11, 12) inwardly.

4. The node connector of claim 3, wherein each passage (11, 12) has two slot floors (15, 16, 17, 18) each having a conical course tapering the passage (11, 12) inwardly and at a narrowest point has a separation (25, 26) from each other equivalent at least to the open diameter (19) of the passages (11, 12).

5. The node connector of claim 1, having a discoid cylindrical appearance.

6. The node connector of claim 1, wherein the passages (11, 12) are arranged on both sides of the center plane (20) of the node connector (10).

7. The node connector of claim 1, wherein support points (23, 24) for anchoring elements (34) of the rod-shaped construction elements (31, 32) are arranged at openings (21, 22) of the passages (11, 12).

8. The node connector of claim 3, wherein the slot floors (15, 17) of the one passage (11) relative to an axis of rotation (43) of the node connector (10) defined by the connection receiving part (13) are rotationally symmetrical relative to the slot floors (16, 18) of the other passage (12), whereby rotational symmetry follows a 2-digit axis of rotation.

9. The node connector of claim 3, wherein a material bridge penetrates both passages (11, 12) in a symmetrical separation relative to the slot floors (16, 16) of the two passages (11, 12), wherein the separation is equivalent at least to the open diameter (19) of the passages (11, 12).

10. The node connector of claim 9, wherein the material bridge is a bolt (37).
